(19) United States
(12) Patent Application Publication
(10) Pub. No.: US 2018/0230576 A1
(43) Pub. Date: Aug. 16, 2018

(54) TITANIUM ALUMINIDE ALLOYS AND TURBINE COMPONENTS

(71) Applicant: GENERAL ELECTRIC COMPANY, Schenectady, NY (US)

(72) Inventors: Stephen Joseph BALSONE, Lebanon, OH (US); Dwight Eric DAVIDSON, Greer, SC (US); Michael Francis Xavier GIGLIOTTI, JR., Niskayuna, NY (US); Pazhayannur Ramanathan SUBRAMANIAN, Schenectady, NY (US); Akane SUZUKI, Ballston Spa, NY (US)

(21) Appl. No.: 15/432,513

(22) Filed: Feb. 14, 2017

(51) Int. Cl. C22C 14/00; F01D 5/02; F01D 5/28

(52) U.S. Cl. CPC C22C 14/00; F01D 5/02; F05D 2300/174; F05D 2220/30; F01D 5/28

(57) ABSTRACT

In some embodiments, a gamma titanium aluminide alloy consists essentially of, in atomic percent, 38 to about 50% aluminum, 1 to about 6% niobium, 0.25 to about 2% tungsten, 0.01 to about 1.5% boron, up to about 1% carbon, optionally up to about 2% chromium, optionally up to about 2% vanadium, up to about 2% manganese, and the balance titanium and incidental impurities. In some embodiments, the gamma titanium aluminide alloy forms at least a portion of a gas turbine component. In some embodiments, a gamma titanium aluminide alloy, consists essentially of, in atomic percent, about 40 to about 50% aluminum, about 1 to about 5% niobium, about 0.3 to about 1% tungsten, about 0.1 to about 0.3% boron, up to about 0.1% carbon, up to about 2% chromium, up to about 2% vanadium, up to about 2% manganese, up to about 1% molybdenum, and the balance titanium and incidental impurities.

### CROSS REFERENCE TO RELATED APPLICATION

This Application is related to application Ser. No. ______, Attorney Docket No. 269059 (22113-0176), filed contemporaneously with this Application on Feb. 14, 2017, entitled “TITANIUM ALUMINIDE ALLOYS AND TURBINE COMPONENTS” and assigned to the assignee of the present invention, and which is incorporated herein by reference in its entirety.

### FIELD OF THE INVENTION

The present disclosure is directed to titanium aluminide alloys for high temperature gas turbine applications, and in particular to hot-forged titanium aluminide alloys.

### BACKGROUND OF THE INVENTION

Industrial gas turbine power output increases with each successive generation of gas turbines. Associated with the turbine power are parameters that determine the power output regime for the gas turbine. One of these parameters is defined in terms of the rotor speed of the turbine and the exit annulus radii for exhaust gases just downstream of the Last Stage Bucket. This parameter is set forth as AN² where N is related to rotor speed and A is related to the exit annulus radii. As AN² grows in area, so do the bucket pull loads. These increasingly greater loads adversely affect the rotor wheel sizes and the stresses that the metal, including the rotating parts, experiences, as well at the volume of metal that is required to be supported.

In recent years, the AN² value has grown sufficiently to warrant the use of costly Alloy 718, a precipitation-hardenable nickel-chrome alloy, also referred to as INCONEL® 718 (Huntington Alloys Corp., Huntington, W. Va.). Nickel-based alloys, such as Alloy 718, are expensive, time consuming to fabricate into turbine components and are relatively dense and heavy, even when fabricated with hollowed out portions so as to permit internal cooling. The increased size of gas turbines and the increased weight of the turbines is both limiting further growth of these machines and increasing the cost of fabricating the machines.

### SUMMARY OF THE INVENTION

In an exemplary embodiment, a gamma titanium aluminide alloy consists essentially of, in atomic percent, about 38 to about 50% aluminum (Al), about 1 to about 6% niobium (Nb), about 0.25 to about 2% tungsten (W), about 0.01 to about 1.5% boron (B), optionally up to about 1% carbon (C), optionally up to about 2% chromium (Cr), optionally up to about 2% vanadium (V), optionally up to about 2% manganese (Mn), and the balance titanium (Ti) and incidental impurities.

In another exemplary embodiment, a turbine component includes a gamma titanium aluminide alloy consisting essentially of, in atomic percent, about 38 to about 50% Al, about 1 to about 6% Nb, about 0.25 to about 2% W, about 0.01 to about 1.5% B, optionally up to about 1% C, optionally up to about 2% Cr, optionally up to about 2% V, optionally up to about 2% Mn, and the balance Ti and incidental impurities.

In another exemplary embodiment, a gamma titanium aluminide alloy consists essentially of, in atomic percent, about 40 to about 50% Al, about 1 to about 5% Nb, about 0.3 to about 1% W, about 0.1 to about 0.3% B, optionally up to about 0.1% C, optionally up to about 2% Cr, optionally up to about 2% V, optionally up to about 2% Mn, optionally up to about 1% molybdenum (Mo), and the balance Ti and incidental impurities.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWING

FIG. 1 schematically depicts a gas turbine with a component including a γ titanium aluminide alloy in an embodiment of the present disclosure.

### DETAILED DESCRIPTION OF THE INVENTION

Provided are exemplarγ titanium aluminide alloy compositions. Embodiments of the present disclosure, in comparison to compositions not using one or more of the features described herein, have a lower density while withstanding the stresses and creep resistance experienced by the rotor wheels and buckets, are less expensive than superalloy materials conventionally used for turbine components, such as rotor wheels and buckets, have a low density, have improved high temperature properties, have improved high temperature creep resistance, have improved high temperature elongation properties, have improved high temperature ultimate tensile strength, have improved high temperature yield strength, are particularly suitable for use in turbine wheels and turbine buckets as a suitable low cost substitute for nickel-based superalloy systems and highly alloyed steel systems, are characterized by a retained beta (β) phase uniformly distributed in shape and size throughout a γ TiAl matrix, have a high temperature formability at temperatures below about 1365° C. (about 2490° F.), or a combination thereof.

The term “high temperature”, as used herein, refers to a temperature in the range of operating temperatures of a gas turbine. The operating temperature is about 1093° C. (about 2000° F.), alternatively about 1093 to about 1540° C. (about 2000 to about 2800° F.), alternatively about 1093 to about 1200° C. (about 2000 to about 2200° F.), alternatively about 1200° C. (about 2200° F.), alternatively about 1200 to about 1320° C. (about 2200 to about 2400° F.), alternatively about 1320° C. (about 2400° F.), alternatively about 1320 to about 1430° C. (about 2400 to about 2600° F.), alternatively about 1430° C. (about 2600° F.), alternatively about 1430 to about 1540° C. (about 2600 to about 2800° F.), alternatively about 1093° C. (about 2800° F.), alternatively about 1200 to about 1430° C. (about 2200 to about 2600° F.), or any value, range, or sub-range therebetween.

The terms “balance essentiallγ titanium and incidental impurities” and “balance of the alloy essentiallγ titanium”, as used herein, refer to, in addition to titanium, small amounts of impurities and other incidental elements, that are inherent in titanium aluminide alloys, which in character and/or amount do not affect the advantageous aspects of the alloy. Unless otherwise specified, all composition percentages identified herein are atomic percents.

In some embodiments, the compositions are used in high temperature applications, where creep resistance and/or stress rupture resistance is important. In some embodiments, the high temperature application is a gas turbine. In some embodiments, the compositions are used in gas turbine components. In some embodiments, the gas turbine components are buckets or wheels. In some embodiments, the composition is hot forged to form the component.

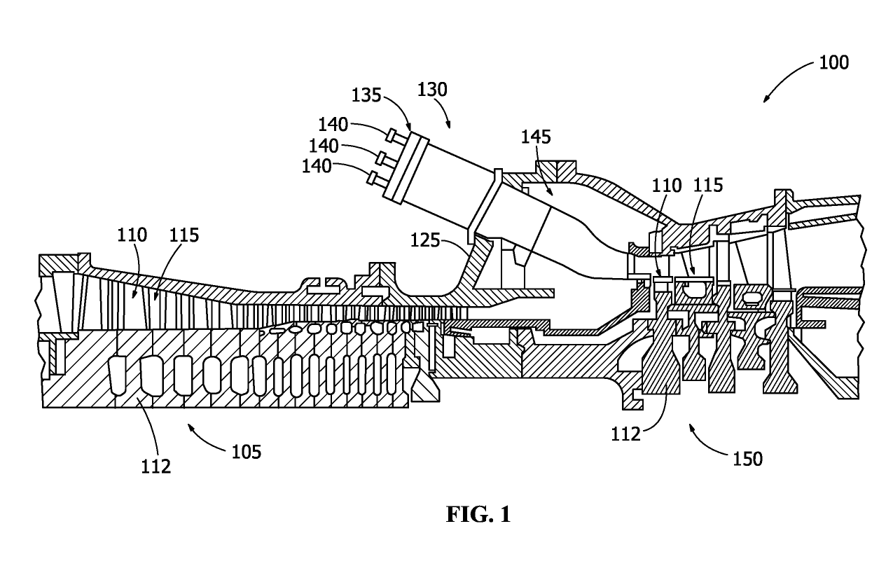

FIG. 1 shows a gas turbine 100 with a compressor section 105, a combustion section 130, and a turbine section 150. The compressor section 105 includes rotating buckets 110 mounted on wheels 112 and non-rotating nozzles 115 structured to compress a fluid. The compressor section 105 may also include a compressor discharge casing 125. The combustion section 130 includes combustion cans 135, fuel nozzles 140, and transition sections 145. Within each of the combustion cans 135, compressed air is received from the compressor section 105 and mixed with fuel received from a fuel source. The mixture is ignited and creates a working fluid. The working fluid generally flows downstream from the aft end of the fuel nozzles 140, downstream through the transition section 145, and into the turbine section 150. The turbine section 150 includes rotating buckets 110 mounted on wheels 112 and non-rotating nozzles 115. The turbine section 150 converts the energy of the working fluid to a mechanical torque. At least one of the turbine components includes a γ titanium aluminide alloy composition. In some embodiments, the turbine component is a bucket 110. In some embodiments, the turbine component is a wheel 112.

In some embodiments, the composition is a γ titanium aluminide alloy. In some embodiments, the γ titanium aluminide alloy is an intermetallic alloy. In some embodiments, the γ titanium aluminide alloy includes, in atomic percent, about 38 to about 50% aluminum (Al), about 1 to about 6% niobium (Nb), about 0.25 to about 2% tungsten (W), about 0.01 to about 1.5% boron (B), optionally up to about 1% carbon (C), optionally up to about 2% vanadium (V), optionally up to about 2% chromium (Cr), optionally up to about 2% manganese (Mn), and the balance essentiallγ titanium (Ti) and incidental impurities.

These γ TiAl alloys preferably provide the advantage of low density, allowing them to be used particularly in applications, such as turbine buckets 110, turbine wheels 112, and turbine nozzles 115. These γ TiAl alloys preferably have such a density advantage over currently used materials, specifically nickel-based superalloys and highly alloyed steels, that they may be used without the need to remove metal, such as by hollowing.

The γ TiAl alloys provide a significant cost advantage over nickel-based superalloys and highly-alloyed steels. While the γ TiAl alloys preferably include alloying elements, these alloying elements are preferably present in low amounts. Further, these alloying elements are, for the most part, not strategic and readily available.

In some embodiments, a γ titanium alloy composition that may be used in turbine wheels 112 and turbine buckets 110 consists essentially of, in atomic percent, about 38 to about 50% aluminum (Al), about 1 to about 6% niobium (Nb), about 0.25 to about 2% tungsten (W), about 0.01 to about 1.5% boron (B), optionally up to about 1% carbon (C), optionally up to about 2% vanadium (V), optionally up to about 2% chromium (Cr), optionally up to about 2% manganese (Mn), and the balance essentiallγ titanium (Ti) and incidental impurities.

In some embodiments, the γ titanium aluminide alloy includes, in atomic percent, about 40 to about 50% aluminum (Al), about 1 to about 5% niobium (Nb), about 0.3 to about 1% tungsten (W), about 0.1 to about 0.3% boron (B), optionally up to about 0.1% carbon (C), optionally up to about 2% chromium (Cr), optionally up to about 2% vanadium (V), optionally up to about 2% manganese (Mn), optionally up to about 1% molybdenum (Mo), and the balance essentiallγ titanium (Ti) and incidental impurities. In some embodiments, the total non-Al, non-Ti alloy content is in the range of about 1.4 to about 7.3%, in atomic percent.

The Al may be present in an amount, in atomic percent, in the range of about 38 to about 50%, alternatively about 40 to about 50%, alternatively about 45.5 to about 47.5%, alternatively about 46 to about 47%, alternatively about 46.5%, or any amount, range, or sub-range therebetween.

In this alloy, Nb may be added to improve the oxidation resistance of the alloy. Oxidation resistance is an important property for alloys used in the hot section of a turbine, such as for turbine buckets 110, wheels 112, and seals. The hot exhaust gases tend to deteriorate the alloys used for these components in these applications. The Nb may be added in an amount, in atomic percent, in the range of about 1 to about 6%, alternatively about 1 to about 5%, alternatively about 2 to about 6%, alternatively about 3 to about 5%, alternatively about 3%, or any amount, range, or sub-range therebetween.

Alloys of the present invention have elevated temperature elongation of about 0.85 to about 1%. More specifically, an alloy having about 47% Al, about 2% Cr, about 3.38% Nb, about 0.1 to about 0.2% B, about 0.03 to about 0.06% C, and the balance essentially Ti and incidental impurities has an elongation of about 1% at 2150° F., 1% at 2235° F., 1% at 2350° F., 1% at 2375° F., and 0.85% at 2400° F.

Alloys of the present invention have elevated temperature yield strength of about 52 to about 58 ksi. More specifically, an alloy having about 47% Al, about 2% Cr, about 3.38% Nb, about 0.1 to about 0.2% B, about 0.03 to about 0.06% C, and the balance essentially Ti and incidental impurities has a yield strength of about 52.3 ksi at 2150° F., 54 ksi at 2235° F., 56.3 ksi at 2350° F., 56.8 ksi at 2375° F., and 58 ksi at 2400° F.

Alloys of the present invention have creep strength of about 43 to about 45.5 ksi-in. More specifically, an alloy having about 47% Al, about 2% Cr, about 3.38% Nb, about 0.1 to about 0.2% B, about 0.03 to about 0.06% C, and the balance essentially Ti and incidental impurities has a creep strength of about 45.62 ksi-in at 2150° F., 44.81 ksi-in at 2235° F., 43.72 ksi-in at 2350° F., 43.48 ksi-in at 2375° F., and 43.0 ksi-in at 2400° F.

Alloys of the present invention have a fracture toughness of about 15.22 to about 24.00 MpA m^{1/2}. More specifically, an alloy having about 47% Al, about 2% Cr, about 3.38% Nb, 0.1 to about 0.2% B, 0.03 to about 0.06% C, and the balance essentially Ti and incidental impurities has a fracture toughness of about 15.22 MpA m^{1/2}-in at 2150° F., 18.09 MpA m^{1/2}-in at 2235° F., 21.97 MpA m^{1/2}-in at 2350° F., 22.82 MpA m^{1/2}-in at 2375° F., and 24.0 MpA m^{1/2}-in at 2400° F.

Tungsten may be added to form fine stable grains that restrict grain growth during high temperature processing. The W may be added in an amount, in atomic percent, in the range of about 0.25 to about 2%, alternatively about 0.3 to about 1%, alternatively about 1%, or any amount, range, or sub-range therebetween.

Boron may be added to increase high temperature strength and creep resistance of the γ titanium aluminum alloy. The addition of boron forms a fine phase of TiB₂ that restricts grain growth during high temperature processing. The B may be added in an amount, in atomic percent, in the range of about 0.01 to about 1.5%, alternatively about 0.75 to about 1.5%, alternatively 0.1 to about 0.3%, alternatively about 0.1%, or any amount, range, or sub-range therebetween.

The addition of carbon in small amounts greatly increases the high temperature creep resistance of γ and γ+β titanium aluminide alloys. Creep resistance is an important property for turbine applications, such as turbine buckets 110 and turbine wheels 112, which operate at high temperatures and high rotational speeds. The C may be added in an amount, in atomic percent, up to about 1%, alternatively about 0.01 to about 1%, alternatively up to about 0.1%, alternatively about 0.03%, or any amount, range, or sub-range therebetween.

The Cr may be added in an amount, in atomic percent, up to about 2%, alternatively about 1 to about 2%, alternatively about 1%, or any amount, range, or sub-range therebetween.

Vanadium may be added in amounts from about 1% to about 2% to improve the toughness of the alloy. Toughness is the ability to absorb energy and plastically deform without fracturing. While toughness is a desirable feature in wheels 112, it is an important property in turbine buckets 110, particularly during transient power excursions when the buckets 110 may contact the turbine casing while moving at high speeds. The V may be added in an amount, in atomic percent, up to about 2%, alternatively about 1 to about 2%, alternatively about 1%, or any amount, range, or sub-range therebetween.

The Mn may be added in an amount, in atomic percent, up to about 2%, alternatively about 1 to about 2%, alternatively about 1%, or any amount, range, or sub-range therebetween.

Molybdenum (Mo) may be added as an optional element to enhance ductility and toughness at lower temperatures. Molybdenum also promotes dissolution of the β phase during elevated temperature extrusion to provide a finer distribution of β phase within the matrix after extrusion. The Mo may be added in an amount, in atomic percent, up to about 1%, alternatively about 0.01 to about 1%, alternatively about 1%, or any amount, range, or sub-range therebetween. In some embodiments, Mo is specifically excluded in the formulation of the present alloy.

Tantalum (Ta) is preferably specifically excluded in the formulation of the present alloy.

Decreasing the Al content of the alloy below about 50% increases the amount of a second beta (β) phase that is formed in the alloy at high temperatures. The β phase can be further stabilized by the addition of β stabilizers. As noted above, V, Nb, Mo, Ta, Cr, iron (Fe), and silicon (Si) are all β stabilizers. Ta is not used in this alloy both because of its expense as a strategic alloy and its density. Fe is not used in this alloy because of its density. V, Nb, and Mo are isomorphic β stabilizers that stabilize the β phase to lower temperatures. Cr is a eutectoid β stabilizer that can lower the stabilization temperature of the β phase to room temperature, when Cr is present in sufficient concentrations.

The amount of β phase present in the γ+β titanium aluminide alloy at high temperatures is preferably controlled by careful composition control as set forth above, and the β stabilizers may maintain the β phase to lower temperatures. This is an important feature, as the ease of hot working is improved by increasing the amount of β phase that may be present. Thus, forging and hot extruding at higher strain rate may be accomplished with a greater amount of β phase. Of course, the amount of phase that is maintained must be balanced by other properties, which may include, but are not limited to, creep resistance, ultimate tensile strength, yield strength, elongation, toughness, density, and cost. Increasing the concentration of Ti increases the cost of the alloy as well as the density. Thus, it is desirable to balance the properties of the alloy with the cost, Al being much less dense and much less expensive than Ti.

One hot working process that attempts to maintain the work piece at its maximum elevated temperature throughout the entire operation is isothermal forging. Alloys, such as the present titanium aluminide alloys, that inherently have low forgeability may be difficult to form, and their mechanical properties may vary greatly over small temperature ranges. Isothermal forging may be used to help overcome these properties, when alloying additions, such as described above, are included. Isothermal forging is achieved by heating the die to the temperature of, or slightly below the temperature of, the starting work piece. For example, the die may be preheated prior to forging and maintained at temperature by an outside source of heat, such as quartz lamps, or the die may include controlled heating elements which maintain temperature at a preset level. As forces exerted by the die form the work piece, cooling of the work piece between the mold work interface is eliminated or at least substantially reduced, and thus flow characteristics of the metal are greatly improved. Isothermal forging may or may not be performed in a vacuum or controlled atmosphere. Equipment costs for this manufacturing process are high, and the added expense of this type of operation should be justified on a case by case basis.

In order to perform in gas turbine applications in which the alloys are used as turbine wheels 112 or as turbine buckets 110 attached to turbine wheels 112, the alloys must exhibit high temperature creep resistance as well as satisfactory high temperature ultimate tensile strength (UTS), yield strength (YS) and elongation. The alloys disclosed herein may also be used as seals in turbine applications. Since seals are stationary, high temperature creep resistance is not as important, but the alloy must exhibit high temperature ultimate tensile strength (UTS), yield strength (YS) and elongation.

In some embodiments, the amounts of Al, Nb, W, B, C, Cr, V, Mn, and Ti are selected to provide a predetermined amount of at least one property to the γ titanium aluminide alloy. In some embodiments, the at least one property is materials cost, density, high temperature creep resistance, high temperature elongation, high temperature oxidation resistance, high temperature ultimate tensile strength, high temperature yield strength, or a combination thereof.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A gamma titanium aluminide alloy consisting essentially of, in atomic percent:
about 38 to about 50% aluminum (Al);
about 1 to about 6% niobium (Nb);
about 0.25 to about 2% tungsten (W);
about 0.01 to about 1.5% boron (B);
optionally up to about 1% carbon (C);
optionally up to about 2% chromium (Cr);
optionally up to about 2% vanadium (V);
optionally up to about 2% manganese (Mn); and
the balance titanium (Ti) and incidental impurities.

2. The gamma titanium aluminide alloy of claim 1, wherein the Cr is present at about 1 to about 2%, in atomic percent.

3. The gamma titanium aluminide alloy of claim 1, wherein the Mn is present at about 1 to about 2%, in atomic percent.

4. The gamma titanium aluminide alloy of claim 1, wherein the V is present at about 1 to about 2%, in atomic percent.

5. The gamma titanium aluminide alloy of claim 1, wherein the Al is present at about 46 to about 47%, the Nb is present at about 3 to about 5%, and the W is present at about 0.3 to about 1%, in atomic percent.

6. The gamma titanium aluminide alloy of claim 1, wherein the Al is present at about 45.5 to about 47.5% and the Nb is present at about 5%, in atomic percent.

7. The gamma titanium aluminide alloy of claim 1, wherein the W is present at about 1%, in atomic percent.

8. The gamma titanium aluminide alloy of claim 1, wherein the Nb is present at about 3%, in atomic percent.

9. The gamma titanium aluminide alloy of claim 1, wherein the B is present at about 0.75 to about 1.5%, in atomic percent.

10. The gamma titanium aluminide alloy of claim 1, wherein the C is present at about 0.01 to about 0.1%, in atomic percent.

11. The gamma titanium aluminide alloy of claim 1, wherein the Al is present at about 40 to about 50%, in atomic percent.

12. A turbine component comprising a gamma titanium aluminide alloy consisting essentially of, in atomic percent:
about 38 to about 50% aluminum (Al);
about 1 to about 6% niobium (Nb);
about 0.25 to about 2% tungsten (W);
about 0.01 to about 1.5% boron (B);
optionally up to about 1% carbon (C);
optionally up to about 2% chromium (Cr);
optionally up to about 2% vanadium (V);
optionally up to about 2% manganese (Mn); and
the balance titanium (Ti) and incidental impurities.

13. The turbine component of claim 12, wherein the turbine component is a wheel or a bucket.

14. The turbine component of claim 12, wherein the B is present at about 0.75 to about 1.5%, in atomic percent.

15. The turbine component of claim 12, wherein the C is present at about 0.01 to about 0.1%, in atomic percent.

16. A gamma titanium aluminide alloy, consisting essentially of, in atomic percent:
about 40 to about 50% aluminum (Al);
about 1 to about 5% niobium (Nb);
about 0.3 to about 1% tungsten (W);
about 0.1 to about 0.3% boron (B);
optionally up to about 0.1% carbon (C);
optionally up to about 2% chromium (Cr);
optionally up to about 2% vanadium (V);
optionally up to about 2% manganese (Mn);
optionally up to about 1% molybdenum (Mo); and
the balance titanium (Ti) and incidental impurities.

17. The gamma titanium aluminide alloy of claim 16, wherein the Al is present at about 45.5 to about 46.5%, the Nb is present at about 3%, the W is present at about 1%, the B is present at about 0.1%, and the C is present at about 0.03%, in atomic percent.

18. The gamma titanium aluminide alloy of claim 16, wherein the Al is present at about 46.5%, in atomic percent.

19. The gamma titanium aluminide alloy of claim 16, wherein the Mo is present at about 1%, in atomic percent.

20. The gamma titanium aluminide alloy of claim 16, wherein the Nb, the W, the B, and the Mo are present in a total amount of about 1.4 to about 7.3%, in atomic percent.
